(19) United States
(12) Patent Application Publication
(10) Pub. No.: US 2026/0039998 A1
(43) Pub. Date: Feb. 5, 2026

(54) ACTIVATION OF GOOSENECK MICROPHONE IN INTEGRATED GOOSENECK/TABLE MICROPHONE DEVICE

(71) Applicant: Cisco Technology, Inc., San Jose, CA (US)

(72) Inventor: Bjørn Winsvold, Tranby (NO)

(21) Appl. No.: 18/794,187

(22) Filed: Aug. 5, 2024

(51) Int. Cl. H04R 1/32; H04R 1/08

(52) U.S. Cl. CPC H04R 1/326; H04R 1/083; H04R 2410/01; H04R 2430/01; H04R 2430/20

(57) ABSTRACT

A method is provided that includes detecting audio with a first microphone unit of a hybrid microphone device in a relatively narrow angular sector, and detecting, with a multi-directional microphone unit of the hybrid microphone device, audio in a relatively wide angular sector range that encompasses the relatively narrow angular sector. The method further includes determining a direction of arrival of detected audio from outputs of the multi-directional microphone unit, and selecting for output the audio detected by the first microphone unit when the direction of arrival of the detected audio by the multi-directional microphone unit is a desired direction of arrival.

### TECHNICAL FIELD

The present disclosure relates to activation of microphones for conference and other similar applications.

### BACKGROUND

So called “gooseneck” microphones are widely used in conference rooms with many participants where typically only one person is talking at a time. For example, gooseneck microphones are used in boardrooms, government hearing rooms, etc.

Gooseneck microphones have the advantage that they can detect audio well from the close/nearby speaker, but detect very little noise/undesirable audio from the surroundings. However, gooseneck microphones do not detect sound very well when a person does not speak directly into the microphone. For more natural conversation across a table, and also across the local meeting rooms and remote meeting rooms connected in a video conference session, gooseneck microphones may not be the optimal microphone choice. Traditional tabletop microphones may be more suitable for such user scenarios.

### BRIEF DESCRIPTION OF THE DRAWINGS

FIG. 1 is a block diagram depicting a system in which hybrid microphone devices may be used in a conference room or similar setting, according to an example embodiment.

FIG. 2A is a perspective view of a hybrid microphone device according to an example embodiment.

FIG. 2B is a top view of a multi-directional microphone unit that forms a part of the hybrid microphone device shown in FIG. 2A, according to an example embodiment.

FIG. 2C is a block diagram of a hybrid microphone device according to an example embodiment.

FIG. 3 is a functional block diagram of the signal processing operations performed by the hybrid microphone device, according to an example embodiment.

FIG. 4 is a flow chart of a process performed by a hybrid microphone device, according to an example embodiment.

FIG. 5 is a diagram of a conference table on which multiple hybrid microphone devices are positioned, and illustrating an example operational use case, according to an example embodiment.

FIG. 6 is a flow chart depicting, at a high level, a method for controlling audio from a hybrid microphone device, according to an example embodiment.

FIG. 7 is a diagram of a conference table on which a plurality of multi-directional microphones may be deployed, any of which may be configured to mute audio detected outside an allowed angular sector, according to an example embodiment.

### DETAILED DESCRIPTION

### Overview

According to one embodiment, a method is provided that includes detecting audio with a first microphone unit of a hybrid microphone device in a relatively narrow angular sector, and detecting, with a multi-directional microphone unit of the hybrid microphone device, audio in a relatively wide angular sector range that encompasses the relatively narrow angular sector. The method further includes determining a direction of arrival of detected audio from outputs of the multi-directional microphone unit, and selecting for output the audio detected by the first microphone unit when the direction of arrival of the detected audio by the multi-directional microphone unit is a desired direction of arrival.

### Example Embodiments

In an example meeting room arrangement, such as a boardroom, there may be as many as 20 seats (or more) around a conference table with one gooseneck microphone positioned on the table for each seat. In order to coordinate audio detection for a video conference endpoint device, expensive and advanced digital signal processing techniques are used in order to handle all the goosenecks microphones around the table. The digital processing techniques include acoustic echo cancelling of each individual microphone and auto-mixing of the microphones. Set- up and configuration of such systems can be time-consuming and costly. Often, an external audio-visual (AV)-integrator company is hired for the installation and configuration of the system, including configuration of the gooseneck microphones with the video conference endpoint unit.

According to the embodiments presented herein, a flexible and powerful hybrid gooseneck-tabletop microphone apparatus is provided that combines features of both gooseneck microphones and directional tabletop microphones. This hybrid gooseneck-tabletop microphone apparatus can be configured to provide a more robust and reliable way to not pass a signal to a microphone mix than is otherwise possible with a conventional gooseneck microphone alone. A conventional gooseneck microphone uses signal level and a voice activity detector as input to decide whether the microphone signal should be included in the mix or not. The hybrid gooseneck-tabletop microphone has, in addition to signal level and voice activity detection, audio directional of arrival (DOA) estimation as input to the mixer. The output from the gooseneck microphone is passed on to the mixer only when detected audio (by the multi-directional microphone unit) is determined to arrive from an allowed angular sector. Such auto-gating or auto-un-gating is based on the angle (DOA) information and can be used to “open up” the gooseneck microphone automatically as soon as the multi-directional microphone unit detects that the audio arrives from the allowed sector. This can result in more efficient noise reduction of noise, and provides a significant advantage compared to conventional gooseneck microphones.

The multi-directional microphone may include a relatively powerful processor that performs echo cancellation and transmits the signal representing the audio to a video conference endpoint unit that performs audio and video encoding via a secure audio-over-ethernet channel. As a result, the use of hybrid gooseneck-tabletop microphones in a conference room setting scales very well to handle many gooseneck microphones without adding an expensive processor. Moreover, since the signal received at the audio encoder at the video conference endpoint is already echo cancelled, the extra processing load per microphone on the codec is minimal.

Another advantage with the suggested hybrid gooseneck-tabletop microphone apparatus is that it can be configured to change behavior and switch from a gooseneck microphone to a tabletop microphone on-the-fly, either manually from a touchscreen device or button, or automatically using video and/or audio scene detection techniques in the conference room. For example, in the beginning of a meeting when people are entering the conference room and doing some general “chit-chat” conversations, it would be better for the remote participants that are connected to a video conference session with the conference room to actually hear the chit-chat conversations detected by the tabletop microphones instead of just hearing the audio that is detected up by one or two gooseneck microphones. Thus, at the beginning of the meeting, intelligence can be employed on the video conference endpoint to configure the hybrid gooseneck-tabletop microphones to operate in tabletop microphone mode. Such a dual-mode microphone apparatus is not heretofore known.

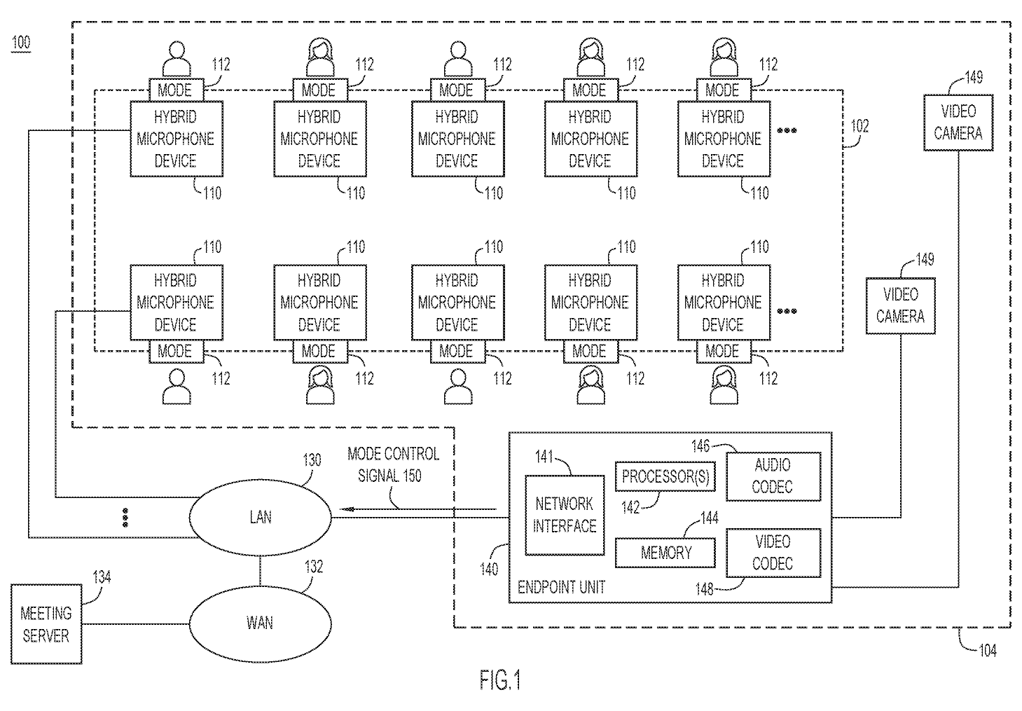

Reference is now made to FIG. 1, which shows a block diagram of a conference room system 100 that may employ one or more hybrid microphone devices according to the embodiments presented herein. The conference room system 100 may be deployed in a conference room or conference space that includes one or more conference tables. FIG. 1 shows one such conference table 102 in a conference room 104. The conference room system 100 includes audio and optionally video capabilities as well, and may communicate, via one or more networks and a meeting server, with similar remotely located conference room systems, desktop endpoint systems, or computer-based meeting clients (running on a desktop computer, laptop computer, tablet, or mobile device) which are not shown in FIG. 1, for simplicity.

The conference room system 100 includes one or more hybrid microphone devices 110, each of which is located at a corresponding seat position around the table 102. The table 102 may take on a variety of shapes (rectangular, L-shaped, oval-shape, etc.). There may be a mode button 112 associated with each hybrid microphone device 110. It should be understood that it is not necessary that the microphone device at each seat position around the table 102 be a hybrid microphone device 110. It is envisioned that it is possible that one or more of the microphones may be a gooseneck microphone or perhaps a tabletop microphone.

Each of the hybrid microphone devices 110 are connected to an endpoint unit 140. In one form, the hybrid microphone devices 110 connect to the endpoint unit 140 by a network (e.g., Ethernet) connection via a local area network (LAN) 130. The LAN 130 may also be connected to a wide area network (WAN) 132, e.g., the Internet, to enable communication with a meeting server 134, for example.

The endpoint unit 140 is configured to perform the audio (and video) signal processing for outbound audio (and video) and for inbound audio (and video). The endpoint unit 140 includes a network interface 141, one or more processors 142, memory 144, an audio codec 146 and a video codec 148. In addition, there may be one or more video cameras 149 that are positioned to capture video of the people sitting around the conference table 102.

The network interface 141 may include a plurality of network ports to enable communication via LAN 130, which in turn is connected to the hybrid network microphone devices 110 and WAN 132. Thus, the network interface 141, which may consist of one or more network interface cards, switches, routers, etc., enables local area network communication and wide area network communication.

The processor(s) 142 may be one or more computer processors (e.g., microprocessors) that execute instructions stored in memory 144 to perform various operations on behalf of the endpoint unit 140. The audio codec 146 performs encoding of outbound audio from the conference room and decoding of inbound audio from a remote site participating in a conference session. Similarly, the video codec 148 performs encoding of outbound video from the conference room (captured by the video camera(s) 149) and decoding of inbound video from a remote site participating in a conference session. The functions of the audio codec 146 and video codec 148 may be integrated into one block/entity, and may be embodied in software executed by the processor(s) 142 or by one or more integrated circuits or digital signal processors. The processor(s) 142 may be perform a variety of video conference endpoint functions that are known in the art. In addition, the processor(s) may analyze video captured by the video camera(s) 149 using artificial intelligence (AI) or other algorithms and/or audio detected in the room, to determine, using scene analysis based on movement of people in the conference room and conversations, whether a meeting is about to start or has just ended. Using such intelligence, the endpoint unit 140 may generate a control signal (mode control signal) 150 that is provided to one or more (or all) hybrid microphone devices 110 in the room to configure them to be in a tabletop multi-directional microphone mode so as to pick up any and all conversations (“chit-chats”) in the room to sent to remote devices participating in the meeting. Then when the processor(s) 142 determine, based on video and/or audio analysis, that all the people in the room are seated and the meeting is about to begin, the processor(s) 142 may generate a control signal (mode control signal) 150 to switch the hybrid microphone devices 110 to a gooseneck operation mode so that only speakers talking into their associated hybrid microphone devices will be captured by the gooseneck microphones of those hybrid microphone devices.

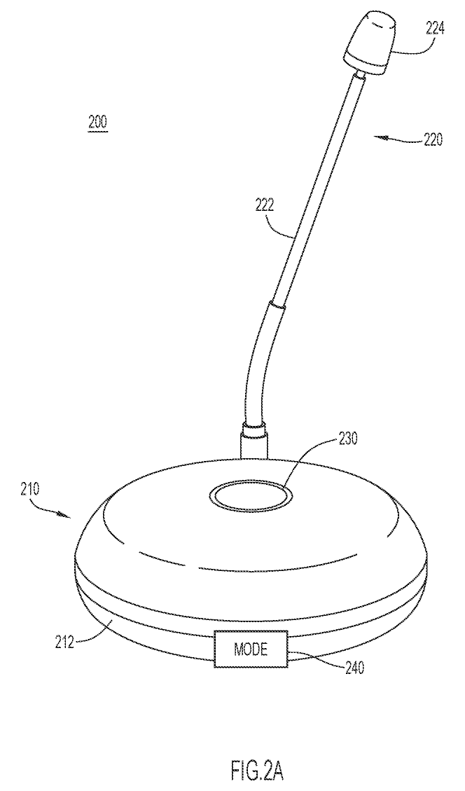

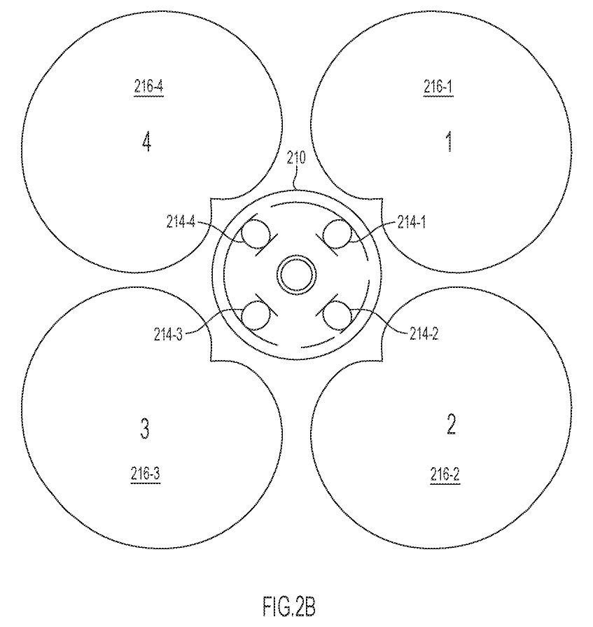

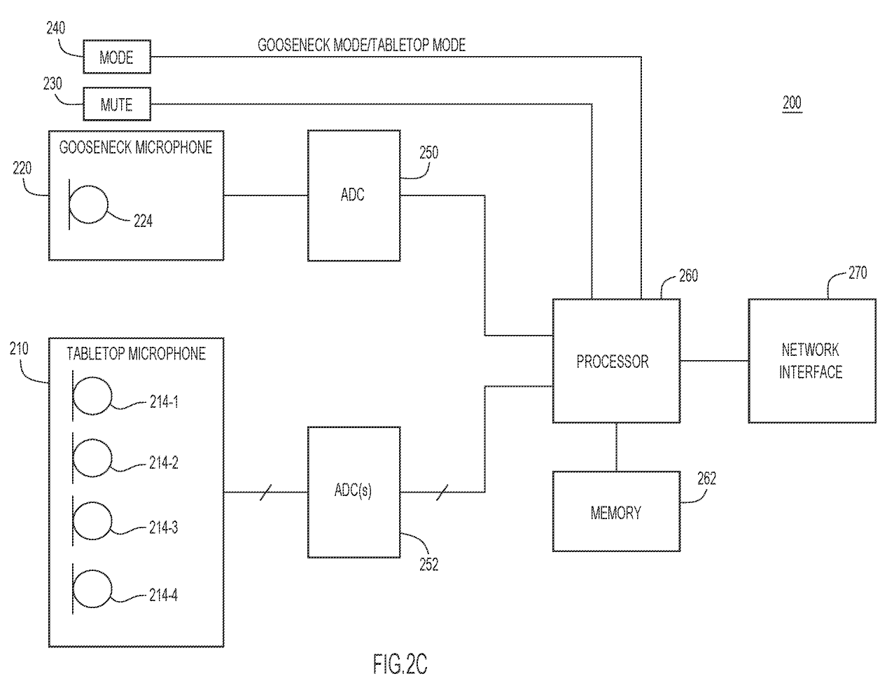

Referring to FIG. 2A, an example of a hybrid microphone device 200 is shown. The hybrid microphone device 200 may be used for any of the hybrid microphone devices 110 shown in FIG. 1. The hybrid microphone device 200 includes a multi-directional microphone unit 210 and a gooseneck microphone unit 220. The gooseneck microphone unit 220 may have an adjustable arm 222 that connects at one end to a base 212 that supports the multi-directional microphone unit 210. A microphone element 224 is disposed on the distal end of the adjustable arm 222. The hybrid microphone device 200 may include a mute button 230 to mute audio from the hybrid microphone device 200, and a mode button 240 that allows a user to switch the hybrid microphone device 200 between a gooseneck operational mode in which audio from the gooseneck microphone unit 220 is allowed to pass through to the output (when the detected audio is within an allowed sector/desired direction of arrival) and audio detected by the multi-directional microphone unit 210 is muted, and a tabletop/multi-directional operational mode in which audio detected by the multi-directional microphone unit 210 is passed through to the output and audio from the gooseneck microphone unit 220 is muted.

FIG. 2B illustrates the multi-directional microphone unit 210 of the hybrid microphone device 200. In one example, the multi-directional microphone unit 210 has four microphone elements 214-1, 214-2,214-3 and 214-4, each of which is oriented to detect audio from a corresponding angular sector (or beam) 216-1, 216-2, 216-3 and 216-4, but which collectively cover substantial 360 degrees around the multi-directional microphone unit 210. The four directional microphone elements 214-1, 214-2, 214-3 and 214-4 can be configured individually – on/off, gain and spatial position (left, center or right).

FIG. 2C illustrates a block diagram of the hybrid microphone device 200, according to an example embodiment. As described above in connection with FIGS. 2A and 2B, the gooseneck microphone unit 220 includes a microphone element 224. The microphone element 224 may be an analog microphone element that produces an analog signal, or a digital micro-electromechanical systems (MEMS) or an optical MEMs microphone element that produces a digital signal. Similarly, the microphone elements 214-1, 214-2, 214-3 and 214-4 may be analog microphone elements that each produce an analog signal, or digital MEMS (or optical MEMS) microphone elements that each produces a digital signal.

When the microphone element 224 is an analog microphone and the microphone elements 214-1, 214-2, 214-3 and 214-4 are analog microphones, the hybrid microphone device 200 includes an analog-to-digital converter (ADC) 250 that obtains the analog audio signal detected by the gooseneck microphone unit 220 and converts it to a digital audio signal. Similarly, a multi-channel ADC 252 (or multiple separate ADCs) are provided to convert analog audio detected by each microphone element 214-1, 214-2, 214-3 and 214-4, to a corresponding digital audio signal. On the other hand, if a digital MEMS microphone is used for the microphone elements 214-1, 214-2, 214-3 and 214-4 and microphone element 224, then the ADCs 250 and 252 are not needed. The digital audio signal/data output by the ADC 250 and ADC(s) 252 are provided to a processor 260. The processor 260 is a microprocessor or microcontroller configured to execute software instructions stored in memory 262. The processor 260 performs operations on the digital audio signal/data derived from the gooseneck microphone unit 220 and the multi-directional microphone unit 210.

Processor 260 may be one or more hardware processors configured to execute various tasks, operations, and/or functions for the hybrid microphone device 200. Processor 260 (e.g., a hardware processor) can execute any type of instructions associated with data to achieve the operations detailed herein. Any of the potential processing elements, microprocessors, image processor, digital signal processor, artificial intelligence (AI)-based processor, graphics processors, video encoders/decoders, logic, and/or machines described herein can be construed as being encompassed within the broad term 'processor'. The processor 260 can transform an element or an article (e.g., data, information) from one state or thing to another state or thing.

Any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory discussed herein may be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

In certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an application specific integrated circuit (ASIC), digital signal processing (DSP) instructions, software [potentially inclusive of object code and source code], etc.) for execution by one or more processor(s), and/or other similar machine, etc. Generally, memory 262 can store data, software, code, instructions (e.g., processor instructions), logic, parameters, combinations thereof, and/or the like used for operations described herein. This includes memory 262 can store data, software, code, instructions (e.g., processor instructions), logic, parameters, combinations thereof, or the like that are executed to carry out operations in accordance with teachings of the present disclosure.

The hybrid microphone device 200 further includes a network interface 270. Network interface 270 may include one or more network interface cards that enable the hybrid microphone device 200 to send and receive data over a network, such as LAN 130 shown in FIG. 1.

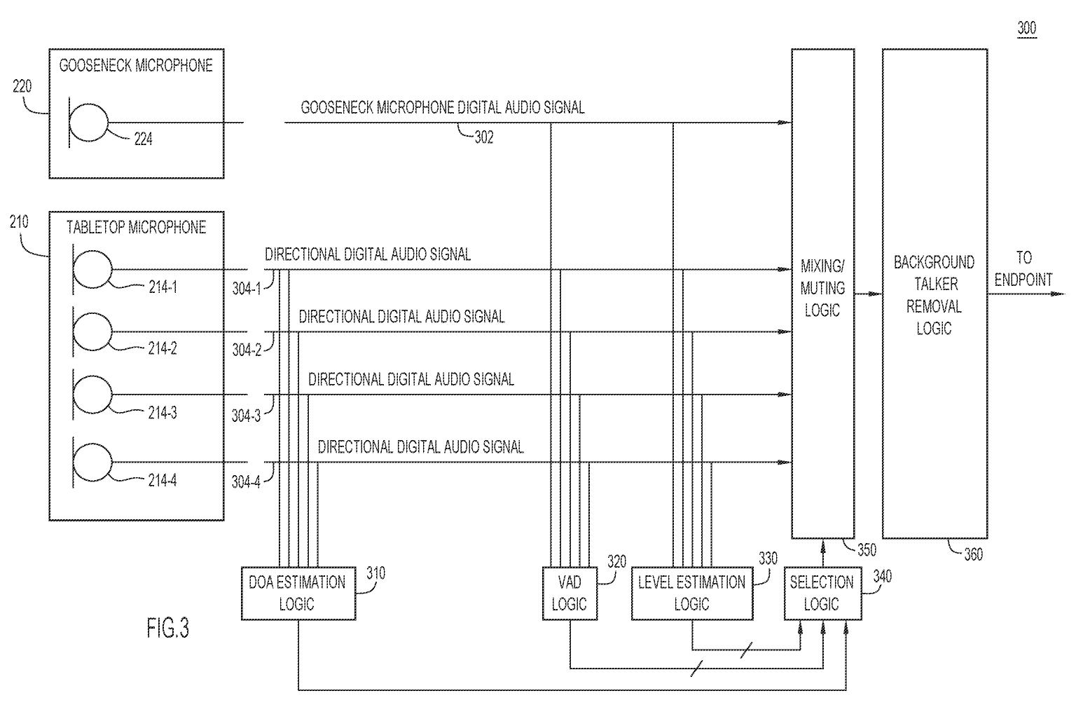

Reference is now made to FIG. 3, with continued reference to FIG. 2C. FIG. 3 shows a functional block diagram 300 of the logic/functions executed by the processor 260 of the hybrid microphone device 200 based on instructions stored in memory 262. While these functions are shown executed in software by processor 260, this is only an example, and it is envisioned that these functions may be executed by analog circuitry.

The gooseneck microphone unit 220 produces a gooseneck microphone audio signal that is either converted to a digital signal to produce a gooseneck microphone digital audio signal 302 or already is a digital audio signal (if the microphone uses digital MEMS, optical MEMs or other technology). Similarly, the multi-directional microphone unit 210 produces tabletop microphone audio signals that are converted to digital signals to produce directional digital audio signals 304-1, 304-2, 304-3 and 304-4 from the analog signals (or already are digital signals if digital MEMS or optical MEMS or other technology is used) output by microphone elements 214-1, 214-2, 214-3, and 214-4, respectively.

The logic/functions executed by the processor 260 include direction of arrival (DOA) estimation logic 310, voice activity detection (VAD) logic 320, level estimation logic 330, selection logic 340, mixing/muting logic 350 and background talker removal logic 360. The DOA estimation logic 310 operates on the digital audio signals derived from the individual microphone elements 214-1 through 214-4 of the multi-directional microphone unit 210 to determine a direction of arrival of audio detected by the multi-directional microphone unit 210. The DOA estimation logic 310 generates an output that represents a direction of arrival of audio detected by the microphone elements 214-1, 214-2, 214-3 and 214-4. The DOA estimation logic 310 may use broadband speech audio signals and estimate a DOA as a mean direction from two or more of the directional digital audio signals 304-1, 304-2, 304-3 and 304-4. As an alternative, instead of broadband DOA estimation, a separate DOA estimation is performed for each frequency band in a filter bank that may be used for other purposes, such as acoustic echo cancellation. Thus, a broadband speech audio signal may be divided into a plurality of narrow frequency bands. The DOA of detected audio may be estimated using the time differences, in each of the narrow frequency bands, between the directional digital audio signals 304-1, 304-2, 304-3 and 304-4 detected by the microphone elements 214-1, 214-2, 214-3 and 214-4, respectively.

The VAD logic 320 evaluates the gooseneck microphone digital audio signal 302 as well as the directional digital audio signals 304-1, 304-2, 304-3 and 304-4 to determine whether each signal contains voice audio (voice activity). The VAD logic 320 generates a plurality of VAD indications, one for each of the gooseneck microphone digital audio signal 302 and each of the directional digital audio signals 304-1, 304-2, 304-3 and 304-4.

The level estimation logic 330 evaluates the gooseneck microphone digital audio signal 302 as well as the directional digital audio signals 304-1, 304-2, 304-3 and 304-4 to determine levels of the respective digital audio signals.

The mixing/muting logic 350 receives as input the gooseneck microphone digital audio signal and the directional digital audio signals 304-1, 304-2, 304-3 and 304-4. The selection logic 340 controls the mixing/muting logic 350, based on inputs received from the DOA estimation logic 310, VAD logic 320 and level estimation logic 330 to output the gooseneck microphone digital audio signal 302 when the DOA estimation indicates that the detected audio is within allowed angles, i.e., is from a desired/allowed direction (when the hybrid microphone device is in the gooseneck operation mode). The desired/allowed direction corresponds to a direction of arrival in which the gooseneck microphone unit 220 should detect audio from a person sitting in front of the gooseneck microphone unit 220.

The background talker removal logic 360 uses artificial intelligence (AI) or other analysis methods to remove background speech or other audio (that does not match the speech audio of the gooseneck microphone digital audio signal 302 or the directional digital audio signals 304-1, 304-2, 304-3 and 304-3. The digital audio, after optional processing by the background talker removal logic 360, is sent to the endpoint unit.

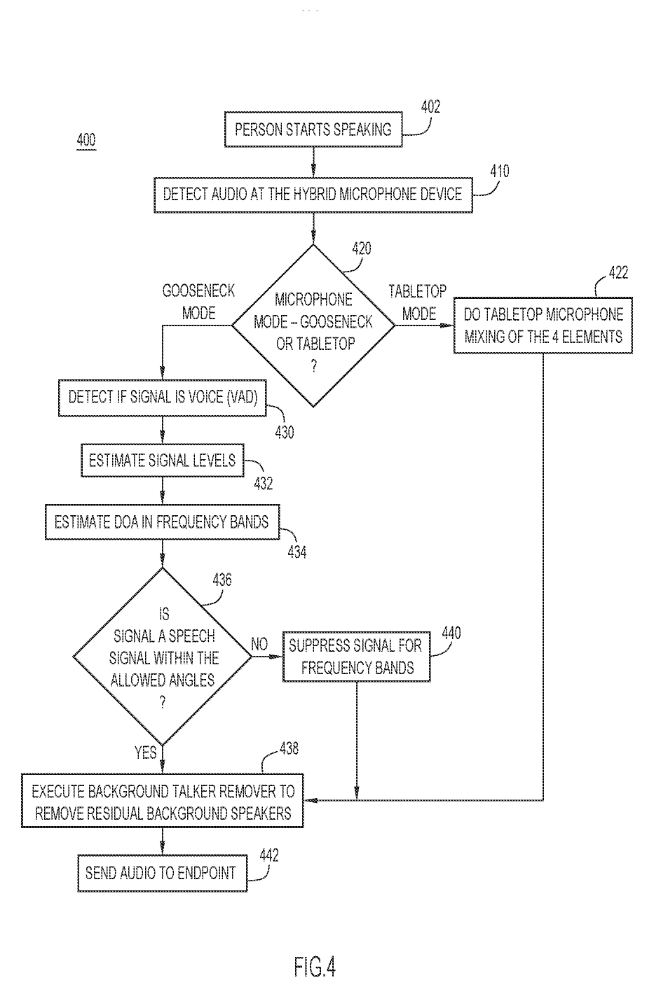

Reference is now made to FIG. 4, with continued reference to FIGS. 2C and 3. FIG. 4 shows a flowchart of a process 400 performed by the hybrid microphone device according to the techniques presented herein. At 402, it is assumed that a person sitting at a table in proximity to a hybrid microphone device starts speaking. At step 410, the hybrid microphone device detects audio associated with the person who is speaking. At step 420, the hybrid microphone device determines whether it is in gooseneck mode or tabletop mode. When the hybrid microphone device is in tabletop mode, then at step 422 the mixing logic mixes the directional digital audio signals associated with the outputs of the microphone elements of the tabletop multi-directional microphone unit of the hybrid microphone device. At step 442, the audio is sent to the endpoint unit.

On the other hand, when the hybrid microphone device is in gooseneck mode, then at step 430, the VAD logic determines whether the digital audio signals associated with the gooseneck microphone and the tabletop microphones contain voice/speech. At step 432, the levels of each of the digital audio signals associated with the gooseneck microphone and the tabletop microphones are determined. At step 434, the directional digital audio signals produced by the tabletop microphone unit are analyzed in individual frequency bands to determine a DOA estimation of detected audio. At step 436, based on the DOA estimation produced in step 434 and the VAD detection at step 430, a determination is made whether the digital audio is speech/voice and has a DOA that is a desired DOA (within an allowed/desired sector configured or set for that hybrid microphone device) that is expected to be detected by the gooseneck microphone of the hybrid microphone device. When it is determined that the detected audio is speech/voice has a desired DOA (received from within the allowed sector), then the digital audio signal from the gooseneck microphone is optionally run through background talker removal at step 438. In addition, when the digital audio signal from the gooseneck microphone is selected, the digital audio signals from the tabletop directional microphone elements may be muted or suppressed. When it is determined at step 436 that the detected audio is not voice/speech and/or does not come from the desired DOA, then at step 440 the digital audio signal is suppressed in the frequency bands of the DOA estimation. In other words, step 440 involves suppressing background noise for those frequencies (filter bands) where DOA estimates that audio to come from directions other than the allowed sector. After noise suppression is performed at step 440, the gooseneck audio may be run through the background noise removal in step 438. In some situations, such as when there are overlapping voices (the person sitting close to the gooseneck microphone is talking at the same time as another distant person is talking), some frequency bands of audio will not, and should not, be suppressed. As a result there may be some residual background noise (after the suppression performed at step 440) that can be removed with the background noise removal. It is envisioned that step 440 could be avoided and noise removal is performed solely by the background noise removal step 438. At step 442, the audio from the gooseneck microphone is sent to the endpoint. Thus, the processor of the hybrid microphone device is configured to perform background noise removal on the output of the first microphone unit (the gooseneck microphone) prior to providing for output the signal representing audio detected by the first microphone unit (the gooseneck microphone), and the processor mutes outputs of the multi-directional microphone unit when the direction of arrival of the detected audio by the multi-directional microphone unit is a desired direction of arrival.

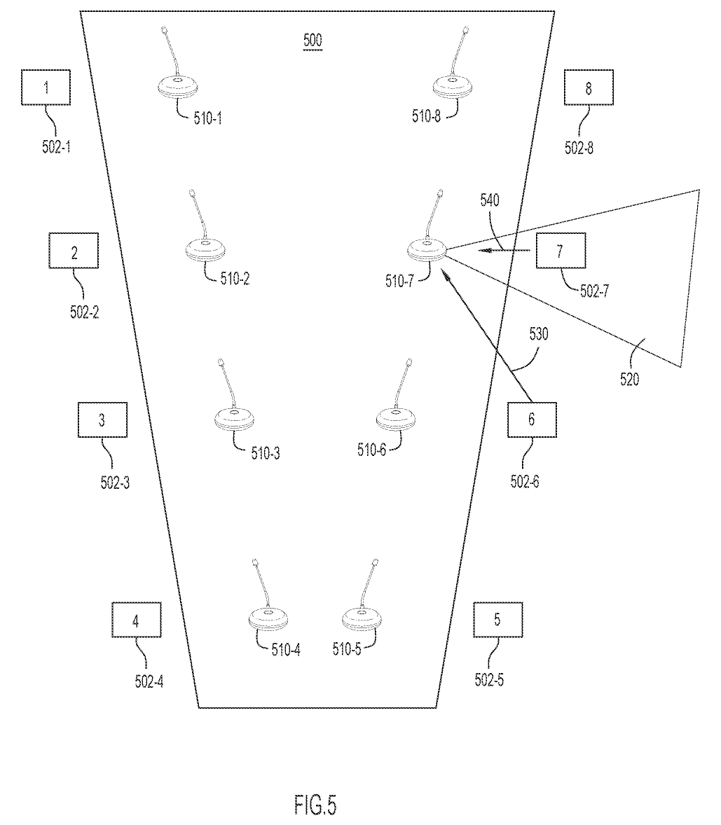

Reference is now made to FIG. 5, which shows a conference table 500 having, as an example, eight (8) seat positions 502-1, 502-2, 502-3, 502-4, 502-5, 502-6,502-7 and 502-8. There is a hybrid microphone device 510-1, 510-2, 510-3, 510-4, 510-5, 510-6, 510-7 and 510-8 at the seat positions 502-1, 502-2, 502-3, 502-4, 502-5, 502-6, 502-7 and 502-8, respectively. Generally, all the hybrid microphone devices 510-1, 510-2, 510-3, 510-4, 510-5, 510-6, 510-7 and 510-8 operate in the same mode (either all in gooseneck mode or all in tabletop mode). When, for example, a hybrid microphone device is in gooseneck mode, it is able to determine an accurate direction of the speaking person, according to the techniques described above. Each hybrid microphone device can define two angles (or in other words - a sector) where the hybrid microphone device is allowed to pick up the sound. A sector 520 is shown in FIG. 5 below for hybrid microphone device 510-7 covering seat position 502-7. FIG. 5 shows that the hybrid microphone device 510-7 will detect that audio 530 (e.g., from a person at seat position 502-6) and will determine that audio 530 has a direction of arrival that is not within the sector 520. Thus, the hybrid microphone device 510-7 will not include in its output any audio from the gooseneck microphone of hybrid microphone device 510-7. On the other hand, if at some point in time, a person at seat position 502-7 begins talking, then audio, shown at 540, from that person will have a direction of arrival that is within the sector 520 and hybrid microphone device 510-7 will include it its output audio detected by the gooseneck microphone of hybrid microphone device 510-7.

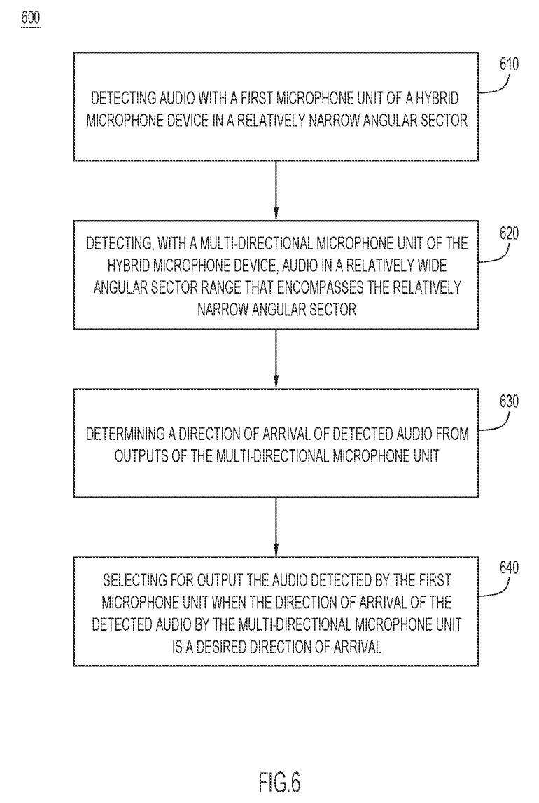

FIG. 6 is a flow chart depicting, at a high level, a method 600 according to an example embodiment. The method 600 includes, at step 610, detecting audio with a first microphone unit of a hybrid microphone device in a relatively narrow angular sector. At step 620, the method 600 includes detecting, with a multi-directional microphone unit of the hybrid microphone device, audio in a relatively wide angular sector range that encompasses the relatively narrow angular sector. At step 630, the method 600 includes determining a direction of arrival of detected audio from outputs of the multi-directional microphone unit. The method 600 includes, at step 640, selecting for output the audio detected by the first microphone when the direction of arrival of the detected audio by the multi-directional microphone unit is a desired direction of arrival.

In summary, the embodiments presented herein in connection with FIGS. 1, 2A – 2C, 3, 4, 5 and 6 provide a hybrid microphone device that combines a gooseneck microphone and a multi-directional (beamforming) microphone. The multi-directional microphone can estimate the direction of the sound and only “open up” the audio detected from the gooseneck microphone when the sound is determined to come from a desired direction. The close gooseneck microphone will secure good audio quality due to the short distance to the speaker that is often associated with use of a gooseneck microphone. The good and direct audio from the gooseneck microphone is output from the hybrid microphone device only when the detected audio is determined to come from the wanted direction of interest (just in front of the microphone) and it will suppress all other sound sources.

Furthermore, the hybrid microphone device can be configured (by the operator) to switch from a close-used gooseneck microphone (with direction-based activation) to a general table microphone with all the advantages such a microphone device has where it can pick up all participants in the room - in comparison to the gooseneck mode where the use case is detecting audio from one talker at a time. The hybrid microphone device can cover both use cases.

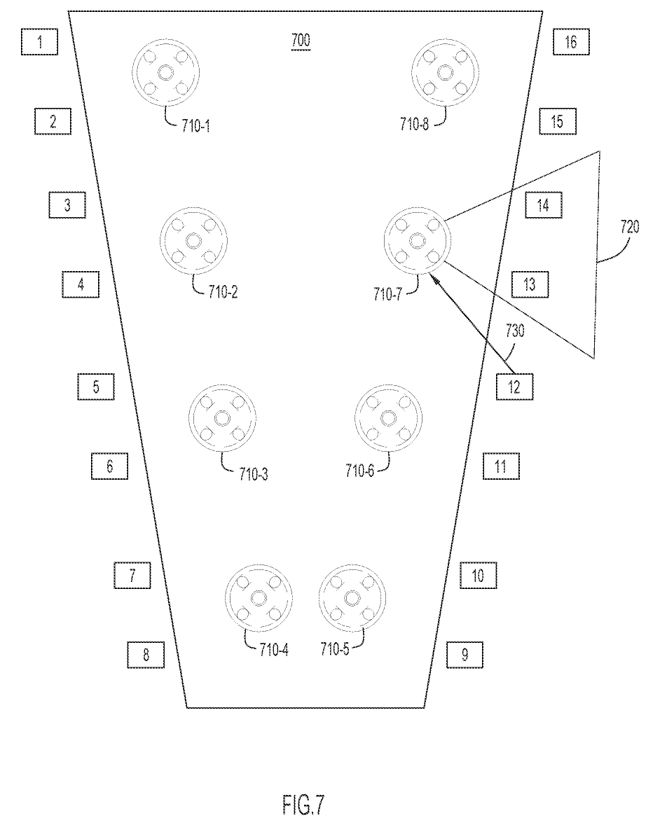

Reference is now made to FIG. 7. In accordance with other aspects of the subject matter presented herein, it may be desirable to have the capability to individually mute tabletop (multi-directional) microphones in a conference room or other similar setting. The challenge with individually muting microphones in a room is that the other un-muted microphones will also pick up audio from the muted zone.

FIG. 7 illustrates a conference table 700 with 14 seat positions and eight multi-directional microphones 710-1, 710-2, 710-3,710-4, 710-5, 710-6, 710-7 and 710-8 positioned around the conference table 700. Each multi-directional microphone thus generally provides coverage for two seat positions (two speakers at two adjacent seat positions). In one example, each of the multi-directional microphones 710-1, 710-2, 710-3, 710-4, 710-5, 710-6, 710-7 and 710-8 may take the form of the tabletop multi-directional microphone unit depicted in FIGS. 2A – 2C (without the gooseneck microphone).

When a person at seat position 11 or a person at seat position 12 is making a local and individual mute of microphone 710-6, the expectation is that audio at seat positions 11 and 12 will be totally muted. However, this is not entirely the case because the nearby microphones 710-5 and 710-7 will still pick up quite a lot of the sound from seat positions 11 and 12. Actually, all microphones, except the muted microphone 710-6, will pick up the sound from seat positions 11 and 12.

As explained above, the direction of arrival for audio detected by a multi-directional microphone, such as those shown in FIG. 7, may be determined based on the time differences between the detected audio signals at the microphone elements. This can provide an accurate direction of a speaking person. Each multi-directional microphone can define a sector between two angles within which the multi-directional microphone is allowed to output detected audio. This is shown by the allowed sector 720 in FIG. 7 for multi-directional microphone 710-7.

When a person sitting in seat position 12 is speaking while microphone 710-6 is muted, microphone 710-7 which is still unmuted, will detect that the sound (shown at 730) from seat position 12 is coming from a position that is outside the allowed sector 720 and the multi-directional microphone 710-7 will mute the audio that it detects.

The angle for the sector 720 within which the multi-directional microphone should let the audio pass through may be configurable from a software tool in order to make individual adaption for the room. Generally, any multi-directional microphone may be configured such that audio coming from an angle (sector) within the software configured and defined allowed sector should be passed through and sound detected from all other angles should be suppressed/muted.

To address a cross-talk problem when there is simultaneous speech from multiple persons at nearby seat positions, separate DOA estimations can be made for each of a plurality of narrow frequency bands For those frequency bands that coincide in both time and frequency, the estimate may still be within the allowed sector, but for most of the frequency bands the DOA will be correct, but the algorithm will attenuate only the frequency bands from direction that is outside the allowed sector 720.

When supporting individual microphone mute, it may be useful to give the user an experience that can be trusted. A user should be 100% certain as to whether the microphone is globally muted for everyone in the conference room or only muted for the person(s) sitting in front of the microphone.

Some possible user experience configurations may include: 1. If the user pushes the mute button on the multi-directional microphone once, the global mute is activated and the light emitting diode (LED) on all multi-directional microphones turn red. 2. If the user pushes the mute button twice in a fairly quick manner (“double-click”), the individual mute is activated. The muted microphone will either start blinking the LED with a red color or a solid blue color. All other microphones continue to show the green LED color. 3. If the mute button on a room control panel is pushed, all microphones in the room will be toggled to the same state.

Another option is to allow the administrator to configure the behavior to, for instance: - Mute on room control panel will toggle mute/unmute on all microphones. - Mute on the multi-directional microphone will only mute the individual microphone.

The techniques depicted by FIG. 7 can support individual mute functionality with a tabletop multi-directional microphone by defining a sector for each tabletop multi-directional microphone where the sound should be picked up. The direction of the sound is detected by a DOA algorithm running on each tabletop multi-directional microphone. If the tabletop multi-directional microphone receives sound from other directions than the accepted sector, the tabletop multi-directional microphone will automatically mute the signal.

The allowed sector may be less than 90 degrees, and the width of the sector may depend on the number of tabletop multi-directional microphone in the setup, the number of seat positions and the distance from each tabletop multi-directional microphone to the speakers. For instance, there may be one tabletop multi-directional microphone per seat position at a short distance to the talkers. In this case, the angle of the allowed sector might be quite small, such as 45-60 degrees.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but does not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

In summary, an apparatus is provided including: a first microphone unit; a multi-directional microphone unit configured to detect audio in a relatively wide angular sector range; and a processor coupled to receive signals derived from output of the first microphone unit and from outputs of the multi-directional microphone unit, wherein the processor is configured to determine a direction of arrival of detected audio from outputs of the multi-directional microphone unit and to provide for output a signal representing audio detected by the first microphone unit when the direction of arrival of the detected audio by the multi-directional microphone unit is a desired direction of arrival.

In some examples, the first microphone unit is a gooseneck microphone configured to detect audio in a relatively narrow angular sector that is within the relatively wide angular sector range of the multi-directional microphone unit.

In some examples, the desired direction of arrival corresponds to a configured allowed angular sector for the direction of arrival of the detected audio.

In some examples, the multi-directional microphone unit includes a plurality of microphone elements collectively arranged to detect audio in a substantially 360 degree directional range of audio.

In some examples, the processor is configured to perform direction of arrival estimation based on a plurality of signals representing outputs from the plurality of microphone elements of the multi-directional microphone unit to determine the direction of arrival of the detected audio.

In some examples, the processor is responsive to a user input to switch between a first operational mode in which the processor outputs the signal representing audio detected by the first microphone unit when the direction of arrival of the detected audio by the multi-directional microphone unit is a desired direction, and a second operational mode in which the processor outputs a signal representing audio detected by the multi-directional microphone unit and mutes audio detected by the first microphone unit.

In some examples the processor is responsive to a control signal to switch between a first operational mode in which the processor outputs the signal representing audio detected by the first microphone unit when the direction of arrival of the detected audio by the multi-directional microphone unit is a desired direction, and a second operational mode in which the processor outputs a signal representing audio detected by the multi-directional microphone unit and mutes audio detected by the first microphone unit.

In some examples, the control signal is provided by an endpoint unit based on analysis performed by the endpoint unit of video and/or audio of a conference space.

In some examples, the processor is further configured to perform background noise removal on the output of the first microphone unit prior to providing for output the signal representing audio detected by the first microphone unit, and the processor mutes outputs of the multi-directional microphone unit when the direction of arrival of the detected audio by the multi-directional microphone unit is a desired direction of arrival.

In addition, presented herein is a method that includes: detecting audio with a first microphone unit of a hybrid microphone device in a relatively narrow angular sector; detecting, with a multi-directional microphone unit of the hybrid microphone device, audio in a relatively wide angular sector range that encompasses the relatively narrow angular sector; determining a direction of arrival of detected audio from outputs of the multi-directional microphone unit; and selecting for output the audio detected by the first microphone unit when the direction of arrival of the detected audio by the multi-directional microphone unit is a desired direction of arrival.

In some examples, the desired direction of arrival corresponds to a configured angular sector for the direction of arrival of the detected audio.

In some examples, the determining includes performing directional of arrival estimation based on a plurality of signals representing outputs from a plurality of microphone elements of the multi-directional microphone unit to determine the direction of arrival of the detected audio.

In some examples, the method includes switching the hybrid microphone device between a first operational mode in which the audio detected by the first microphone unit is output when the direction of arrival of the detected audio by the multi-directional microphone unit is a desired direction, and a second operational mode in which a signal representing audio detected by the multi-directional microphone unit is output and audio detected by the first microphone unit is muted.

In some examples, the switching is responsive to a control signal generated by an endpoint unit based on analysis by the endpoint unit of video and/or audio of a conference space.

In another form, a hybrid microphone device is provided that includes: a gooseneck microphone unit configured to detect audio in a relatively narrow angular sector; a multi-directional microphone unit configured to detect audio in a relatively wide angular sector range that encompasses the relatively narrow angular sector; and a processor coupled to receive signals derived from output of the gooseneck microphone unit and from outputs of the multi-directional microphone unit, wherein the processor is configured to, in a first operational mode, output a signal representing audio detected by the gooseneck microphone unit when the processor determines determine a direction of arrival of detected audio from outputs of the multi-directional microphone unit is a desired direction of arrival and mute audio detected by the multi-directional microphone unit, and in a second operational mode in which the processor outputs a signal representing audio detected by the multi-directional microphone unit and mutes audio detected by the gooseneck microphone unit.

In some examples, the desired direction of arrival corresponds to a configured allowed angular sector for the direction of arrival of the detected audio.

In some examples, the multi-directional microphone unit includes a plurality of microphone elements collectively arranged to detect audio in a substantially 360 degree directional range of audio.

In some examples, the processor is configured to be responsive to a user input to switch between the first operational mode and the second operational mode.

In some examples, the processor is responsive to a control signal provided by an endpoint unit upon the endpoint unit determining based on analysis of video and/or audio of a conference space to switch between the first operational mode and the second operational mode.

In some examples, a system is provided that includes: a plurality of hybrid microphone devices, each hybrid microphone device including: a gooseneck microphone unit configured to detect audio in a relatively narrow angular sector; a multi-directional microphone unit configured to detect audio in a relatively wide angular sector range that encompasses the relatively narrow angular sector; and a processor coupled to receive signals derived from output of the gooseneck microphone unit and from outputs of the multi-directional microphone unit, wherein the processor is configured to, in a first operational mode, output audio detected by the gooseneck microphone unit and mute audio detected by the multi-directional microphone unit, and in a second operational mode, the processor is configured to output audio detected by the multi-directional microphone unit and mute audio detected by the gooseneck microphone unit; and an endpoint unit in communication with the plurality of hybrid microphone devices, wherein the endpoint unit is configured to provide a control signal to the plurality of hybrid microphone devices to configure the plurality of hybrid microphone devices to be either in the first operational mode or the second operational mode.

In some examples, the endpoint unit is configured to generate the control signal provided to the plurality of hybrid microphone devices based on analysis of video and/or audio of a conference space.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source, and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', ‘and/or’ variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. An apparatus comprising:
a first microphone unit;
a multi-directional microphone unit configured to detect audio in a relatively wide angular sector range; and
a processor coupled to receive signals derived from output of the first microphone unit and from outputs of the multi-directional microphone unit, wherein the processor is configured to determine a direction of arrival of detected audio from outputs of the multi-directional microphone unit and to provide for output a signal representing audio detected by the first microphone unit when the direction of arrival of the detected audio by the multi-directional microphone unit is a desired direction of arrival.

2. The apparatus of claim 1, wherein the first microphone unit is a gooseneck microphone configured to detect audio in a relatively narrow angular sector that is within the relatively wide angular sector range of the multi-directional microphone unit.

3. The apparatus of claim 1, wherein the desired direction of arrival corresponds to a configured allowed angular sector for the direction of arrival of the detected audio.

4. The apparatus of claim 1, wherein the multi-directional microphone unit comprises a plurality of microphone elements collectively arranged to detect audio in a substantially 360 degree directional range of audio.

5. The apparatus of claim 4, wherein the processor is configured to perform direction of arrival estimation based on a plurality of signals representing outputs from the plurality of microphone elements of the multi-directional microphone unit to determine the direction of arrival of the detected audio.

6. The apparatus of claim 1, wherein the processor is responsive to a user input to switch between a first operational mode in which the processor outputs the signal representing audio detected by the first microphone unit when the direction of arrival of the detected audio by the multi-directional microphone unit is a desired direction, and a second operational mode in which the processor outputs a signal representing audio detected by the multi-directional microphone unit and mutes audio detected by the first microphone unit.

7. The apparatus of claim 1, wherein the processor is responsive to a control signal to switch between a first operational mode in which the processor outputs the signal representing audio detected by the first microphone unit when the direction of arrival of the detected audio by the multi-directional microphone unit is a desired direction, and a second operational mode in which the processor outputs a signal representing audio detected by the multi-directional microphone unit and mutes audio detected by the first microphone unit.

8. The apparatus of claim 7, wherein the control signal is provided by an endpoint unit based on analysis performed by the endpoint unit of video and/or audio of a conference space.

9. The apparatus of claim 1, wherein the processor is further configured to perform background noise removal on the output of the first microphone unit prior to providing for output the signal representing audio detected by the first microphone unit, and the processor mutes outputs of the multi-directional microphone unit when the direction of arrival of the detected audio by the multi-directional microphone unit is a desired direction of arrival.

10. A method comprising:
detecting audio with a first microphone unit of a hybrid microphone device in a relatively narrow angular sector;
detecting, with a multi-directional microphone unit of the hybrid microphone device, audio in a relatively wide angular sector range that encompasses the relatively narrow angular sector;
determining a direction of arrival of detected audio from outputs of the multi-directional microphone unit; and
selecting for output the audio detected by the first microphone unit when the direction of arrival of the detected audio by the multi-directional microphone unit is a desired direction of arrival.

11. The method of claim 10, wherein the desired direction of arrival corresponds to a configured angular sector for the direction of arrival of the detected audio.

12. The method of claim 10, wherein determining comprises performing directional of arrival estimation based on a plurality of signals representing outputs from a plurality of microphone elements of the multi-directional microphone unit to determine the direction of arrival of the detected audio.

13. The method of claim 10, further comprising switching the hybrid microphone device between a first operational mode in which the audio detected by the first microphone unit is output when the direction of arrival of the detected audio by the multi-directional microphone unit is a desired direction, and a second operational mode in which a signal representing audio detected by the multi-directional microphone unit is output and audio detected by the first microphone unit is muted.

14. The method of claim 13, wherein switching is responsive to a control signal generated by an endpoint unit based on analysis by the endpoint unit of video and/or audio of a conference space.

15. A hybrid microphone device comprising:
a gooseneck microphone unit configured to detect audio in a relatively narrow angular sector;
a multi-directional microphone unit configured to detect audio in a relatively wide angular sector range that encompasses the relatively narrow angular sector; and
a processor coupled to receive signals derived from output of the gooseneck microphone unit and from outputs of the multi-directional microphone unit, wherein the processor is configured to, in a first operational mode, output a signal representing audio detected by the gooseneck microphone unit when the processor determines determine a direction of arrival of detected audio from outputs of the multi-directional microphone unit is a desired direction of arrival and mute audio detected by the multi-directional microphone unit, and in a second operational mode in which the processor outputs a signal representing audio detected by the multi-directional microphone unit and mutes audio detected by the gooseneck microphone unit.

16. The hybrid microphone device of claim 15, wherein the desired direction of arrival corresponds to a configured allowed angular sector for the direction of arrival of the detected audio.

17. The hybrid microphone device of claim 15, wherein the multi-directional microphone unit comprises a plurality of microphone elements collectively arranged to detect audio in a substantially 360 degree directional range of audio.

18. The hybrid microphone device of claim 15, wherein the processor is configured to be responsive to a user input to switch between the first operational mode and the second operational mode.

19. The hybrid microphone device of claim 15, wherein the processor is responsive to a control signal provided by an endpoint unit upon the endpoint unit determining based on analysis of video and/or audio of a conference space to switch between the first operational mode and the second operational mode.

20. A system comprising:
a plurality of hybrid microphone devices, each hybrid microphone device comprising:
a gooseneck microphone unit configured to detect audio in a relatively narrow angular sector;
a multi-directional microphone unit configured to detect audio in a relatively wide angular sector range that encompasses the relatively narrow angular sector; and
a processor coupled to receive signals derived from output of the gooseneck microphone unit and from outputs of the multi-directional microphone unit, wherein the processor is configured to, in a first operational mode, output audio detected by the gooseneck microphone unit and mute audio detected by the multi-directional microphone unit, and in a second operational mode, the processor is configured to output audio detected by the multi-directional microphone unit and mute audio detected by the gooseneck microphone unit; and
an endpoint unit in communication with the plurality of hybrid microphone devices, wherein the endpoint unit is configured to provide a control signal to the plurality of hybrid microphone devices to configure the plurality of hybrid microphone devices to be either in the first operational mode or the second operational mode.

21. The system of claim 20, wherein the endpoint unit is configured to generate the control signal provided to the plurality of hybrid microphone devices based on analysis of video and/or audio of a conference space.
